(19) United States
(12) Patent Application Publication
(10) Pub. No.: US 2025/0148611 A1
(43) Pub. Date: May 8, 2025

(54) A PREDICTION-TUNING CAPSULE NETWORK FOR THERMAL ANOMALY IDENTIFICATION ON BUILDING ENVELOPES AS WELL AS IMAGE CLASSIFICATION AND OBJECT DETECTION

(71) Applicants: Senem Velipasalar, Fayetteville, NY (US); Chenbin Pan, Syracuse, NY (US); Tarek Rakha, Atlanta, GA (US); John Fernandez, Cambridge, MA (US); Norhan Bayomi, Cambridge, MA (US)

(72) Inventors: Senem Velipasalar, Fayetteville, NY (US); Chenbin Pan, Syracuse, NY (US); Tarek Rakha, Atlanta, GA (US); John Fernandez, Cambridge, MA (US); Norhan Bayomi, Cambridge, MA (US)

(21) Appl. No.: 18/837,089

(22) PCT Filed: Feb. 8, 2023
(86) PCT No.: PCT/US23/12591

§ 371 Date: Aug. 8, 2024

Related U.S. Application Data
(60) Provisional application No. 63/307,861, filed on Feb. 8, 2022.

(51) Int. Cl. G06T 7/168; G06T 7/00

(52) U.S. Cl. CPC G06T 7/168; G06T 7/0004; G06T 2207/10048; G06T 2207/20081

(57) ABSTRACT

A system and approach for automatically detecting and classifying thermal anomalies in thermal images of structures such as buildings. The system that can receive a thermal image, autonomously process the image using a machine learning algorithm specifically designed and trained for detecting and classifying thermal anomalies, and then display the classified anomalies. The machine learning algorithm may comprise a neural network and, in one example, may be a prediction-tuning capsule network employing two instance layers, namely, a fully connected PT capsule layer and a locally connected PT capsule layer. The machine learning algorithm may comprise a transformer-based segmentation method for the autonomous heat anomaly segmentation task.

### CROSS-REFERENCE TO RELATED APPLICATIONS

The present application claims priority to U.S. Application No. 63/307,861, filed on Feb. 8, 2022.

### STATEMENT REGARDING FEDERALLY SPONSORED RESEARCH AND DEVELOPMENT

This invention was made with government support under Award No. DE-EE0008680 awarded by the U.S. Department of Energy, Office of Energy Efficiency and Renewable Energy (EERE). The government has certain rights in the invention.

### BACKGROUND OF THE INVENTION

### 1. Field of the Invention

The present invention relates to a capsule network design for deep neural network architectures and, more specifically, to the application of the design for image classification, object detection and thermal image interpretation and segmentation.

### 2. Description of the Related Art

The residential and commercial building sector accounts for 39% of total U.S. energy consumption and 40% of CO2 emissions, according to the February 2021 report of Total Energy Monthly Data of U.S. Energy Information Administration. More than half of all U.S. commercial buildings were built before 1970 and have deteriorated severely, which has resulted in general lower efficiency performance. Maintaining the energy efficiency of an aging built environment is essential in achieving a sustainable living environment. Therefore, to address the inefficiency of deteriorating infrastructure and building stock, energy retrofitting practices should be implemented. The identification, diagnosis, and repair of issues causing additional energy loss in building systems and envelopes are necessary to improve building energy efficiency.

To identify and diagnose energy-related issues in building envelopes, energy auditors typically use professional tools to inspect building envelopes and detect thermal anomaly areas indicating infiltration/exfiltration and thermal bridge issues. Advanced infrared (IR) thermography technology is experiencing a growing trend in the area of building diagnostics, enabling a rapid and accurate detection of thermal anomalies with lower costs and safety risks. Thermal anomalies (i.e., infiltration/exfiltration, thermal bridge) can be effectively identified from captured infrared images based on their temperature patterns. However, vast amounts of human workload and efforts are required to manually scan and analyze the captured infrared images. There are challenges in the processing of infrared images to detect such thermal anomalies through advanced computer vision algorithms and computational solutions. These are mainly associated with inconsistent patterns caused by diversity of materials, building components, time of day, and season of year.

Emerging deep learning-based segmentation techniques can provide opportunities to autonomously detect, segment and classify such heat anomalies with robustness to handle such inconsistency issues. The output of such automated models can significantly improve the efficiency of decision-making for building envelope retrofitting and maintenance. However, many approaches, such as convolutional neural networks, do not have an inherent mechanism to explicitly learn or use spatial relationships in a visual scene, which limits their ability to accurately detect compositional structures. Accordingly, there is a need in the art for an approach that can be used to detect and classify thermal anomalies in thermal images of structures such as buildings.

### BRIEF SUMMARY OF THE INVENTION

The present invention provides an approach for automatically detecting and classifying thermal anomalies in thermal images of structures such as buildings. In one aspect, the invention is a system that can receive a thermal image, autonomously process the image using a machine learning algorithm specifically designed and trained for detecting and classifying thermal anomalies, and then display the classified anomalies. The machine learning algorithm may comprises a neural network and, in one example, may be a (i) a Prediction-Tuning Capsule Network (PT-CapsNet), and two instance layers, namely, a fully connected PT capsule layer (FC-PT-Caps) and a locally connected PT capsule layer (LC-PT-Caps), that are introduced to make the PT-CapsNet applicable to various deep learning architectures; (ii) a capsule network-based semantic segmentation model, referred to as CapsLab, that uses semantic segmentation to deal with the thermal anomalies, since the anomaly region on the thermal image can be of any shape, and it is not necessary to differentiate the instances of the same class; and (iii) application of PT-CapsNet to image classification and object detection tasks. In another aspect, the machine learning algorithm may comprise a transformer-based segmentation method, such as Mask2Former, used for the autonomous heat anomaly segmentation task.

There are numerous ways of applying computer vision methodologies to solve the thermal anomaly identification problem. A data-driven approach is more desirable, especially when annotated data is available, since it removes the need for hand-crafted features or feature engineering, and many assumptions regarding the anomaly identification. Machine learning models have provided the state-of-the-art performance on majority of the computer vision tasks over the last decade and become the de-facto practice in applying computer vision solutions to many real-world problems. Since anomaly regions can appear in various random shapes and sizes in IR images, a plausible approach to tackle this problem can be image segmentation, which is the process of partitioning an image into multiple regions, which correspond to meaningful entities of interest. One type of image segmentation approach that can be used for anomaly detection is semantic segmentation, which generates a single mask for multiple/combined occurrences of the same semantically meaningful entities.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is a schematic of an image anomaly detection and classification system according to the present invention.

FIG. 2 is a PT-CapsNet system constructed for an image anomaly detection and classification system according to the present invention.

FIG. 3 is a schematic of a capsule network-based semantic segmentation model according to the present invention.

FIG. 4 is the architecture of a fully connected PT capsule layer (FC-PT-Caps) according to the present invention.

FIG. 5 is the architecture of a locally connected PT capsule layer (LC-PT-Caps) according to the present invention.

FIG. 6 is a series of images showing low, hidden and high capsule based detection of a series of images.

FIG. 7 is a series of images of a visualization of object detection results according to the present invention as compared to a conventional approach.

FIG. 8 is series of exemplary output images together with their ground truth and mIoU and Anomaly Identification Metric (AIM) scores as follows from left to right: Input IR image, Ground truth, outputs of CapsLab, DeepLabv3+, MSOCR and MaskFormer.

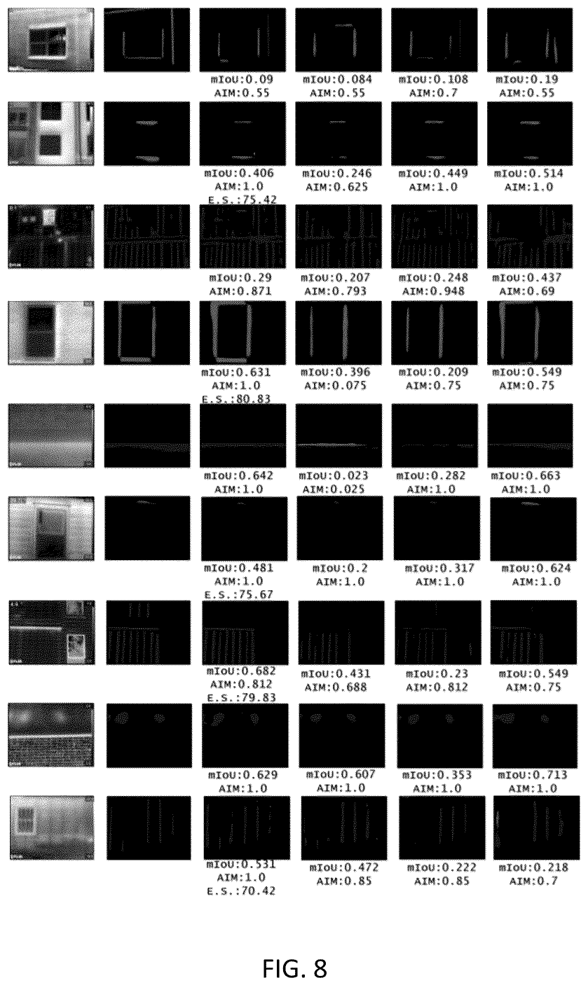

### DETAILED DESCRIPTION OF THE INVENTION

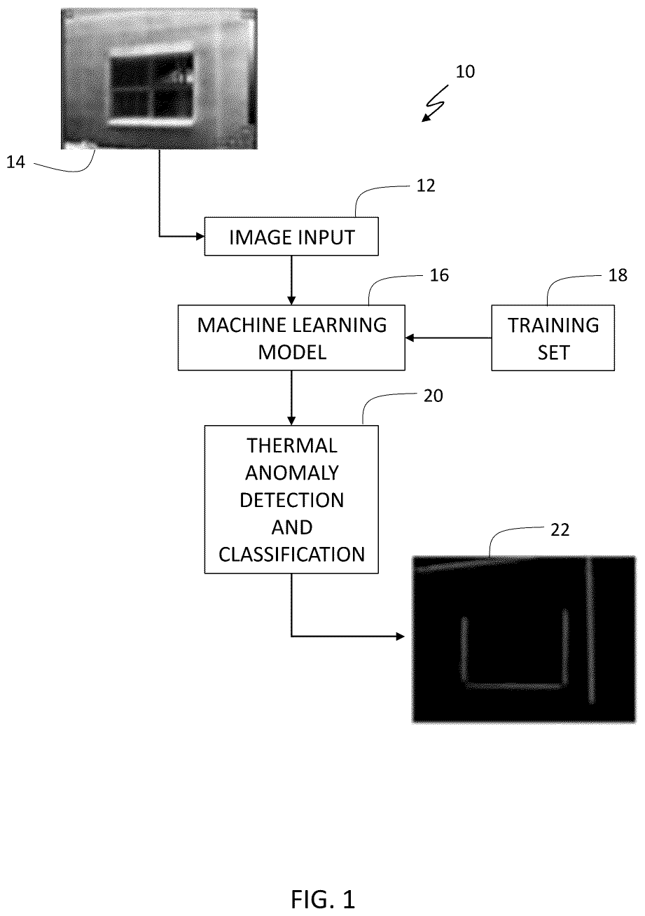

Referring to the figures, wherein like numeral refer to like parts throughout, there is seen in FIG. 1 a high level schematic of a system 10 according to the present invention. System 10 includes an input 12 for receiving a thermal image data 14. Thermal image data 14 may comprise a high quality digital thermal image of a structure to be analyzed for thermal anomalies. Thermal image data 14 is processed by a machine learning module 16, such as a neural network, that has been trained using a training data set 18 configured and arranged according to the present invention. System 10 analyzes the thermal image data 14 to provide thermal anomaly detection and classification 20 and provides an output 22, such as the output image 22 that has been labelled to identify thermal anomalies and provide a classification of the nature of the thermal anomaly. As explained below, machine learning module 16 preferable comprises a neural network configured for use in connection with system 10.

### Example 1

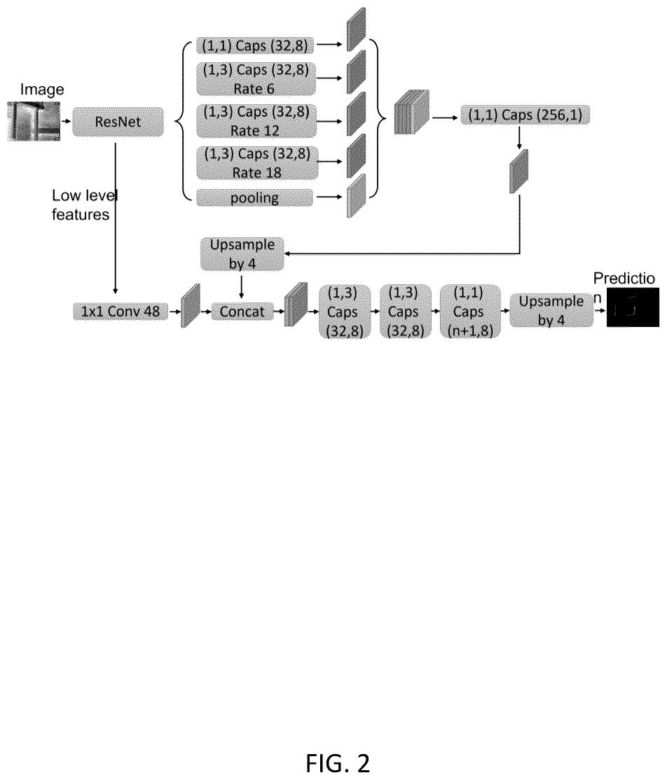

In one example of the present invention, the neutral network may comprise a capsule network-based semantic segmentation model, referred to as CapsLab, for performing thermal anomaly identification on an inputted image and outputting a prediction image, as seen in FIG. 2. The model is based upon a DeepLabV3+ model that applies atrous convolutions to capture multi-scale context. For each location, an atrous convolution filter is applied over the input feature map, where the atrous rate corresponds to the stride with which the input signal is sampled. By adjusting the rate, the field-of-view of the operation can be adaptively modified. This architecture concatenates feature maps from atrous convolutions with different rates. Thus, it allows us to enlarge the reception field to incorporate larger context and offers an efficient mechanism to control the reception field to find the best trade-off between accurate localization (small field-of-view) and context assimilation (large field-of-view). In other words, it is possible to gather more complete and meaningful information from images than using DeepLabV3+.

There are mainly three modules in DeepLabV3+: (i) backbone neural network model for feature extraction, (ii) atrous spatial pyramid pooling (ASPP), and (iii) decoder for mask generation. The input image is firstly sent to the backbone to extract low-level features, which are then forwarded to ASPP to extract high-level features with various fields of view. Then, both features are concatenated and fed into the decoder to make predictions for the segmentation mask.

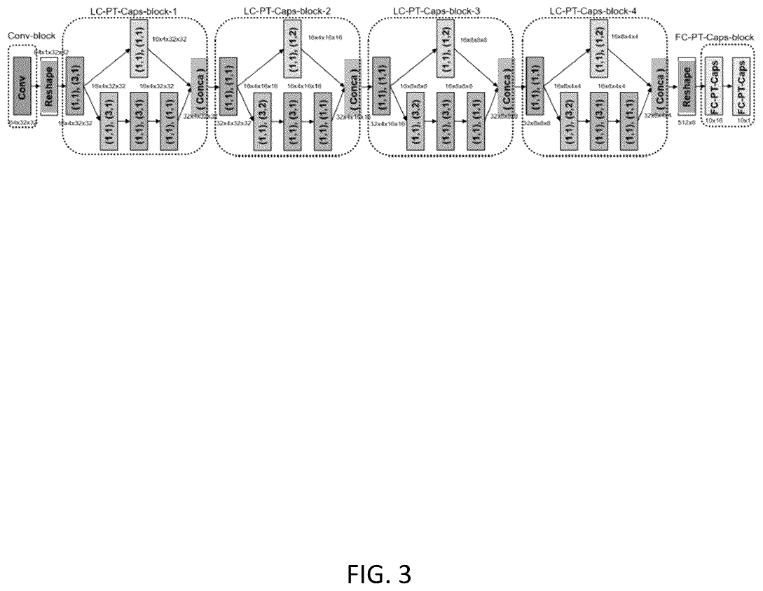

In the present invention, the convolution layer and the FC layer of DeepLabV3+ have been replaced with locally connected PT capsule layer (LC-PT-Caps) and a fully connected PT capsule layer (FC-PT-Caps), respectively, to build a capsule-based model, as further illustrated in FIG. 3. The model allows the use of capsules for more difficult vision tasks and provides wider applicability and provides better than or comparable performance to CNN-based baselines on these complex tasks.

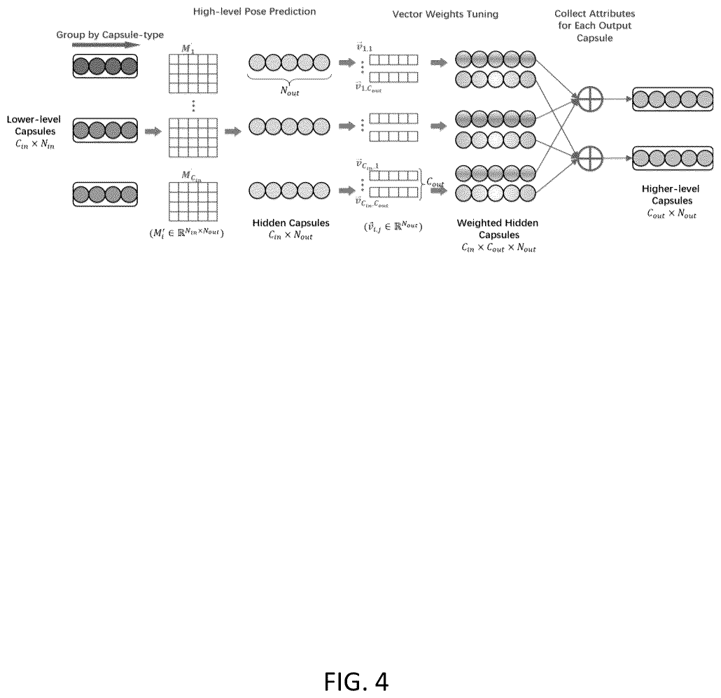

The fully connected, prediction tuning capsule layer (FC-PT-Caps) is seen in FIG. 4. With this layer, instead of having each input capsule make predictions for all output capsules, the low-level capsules 12, XϵR^{Cin×Nin}, with low-level pose are first transformed to the capsules with high-level pose 14 by employing Cᵢₙ-many transformation matrices (M′∈R^{Nin×Nout}) to perform matrix multiplication with the corresponding input capsules. The resulting capsules with high-level pose are referred to as hidden capsules 16, H∈R^{Cin×Nout.} The goal is to learn the relationships between the low-level and high-level poses of the input capsules. Then, to probe the relationships between low-level and high-level capsule types, vector-form weights, instead of scalar weights, are used to refine the hidden capsules. This process is referred to as the vector-tuning process 18. More specifically, when deriving each high-level capsule, there will be Cᵢₙ-many vector-form weights (\vec{v}∈R^{Nout}), which are used to perform element-wise multiplication with the corresponding Cᵢₙ-many hidden vectors. After multiplication, the weighted hidden vectors in R^{Cout×Cin×Nout} dimensional space, are summed along the Cᵢₙ axis to obtain the final capsules 20 Y′∈R^{Cout×Nout}. The overall procedure can be expressed by Eq. (3) and Eq. (4):

$$\text{?} = \text{?} \cdot {M}_{i}^{′} \qquad ( 3 )$$

$$\text{?} = {{\sum }_{i}}^{{C}_{in}} \text{?} \times \text{?} , \qquad ( 4 )$$

$$\text{?} \text{indicates text missing or illegible when filed}$$

where i∈[1, Cᵢₙ] and j∈[1, Cₒᵤₜ] indicate the IDs of the ith input capsule and jth output capsule, respectively. Hence, in the first phase, each capsule undergoes pose transformation independently, while in the second phase, each feature in the pose renders high-level capsules independently. When parsing the object relationship, if two instances are mutually exclusive, then they will not be connected, which means that there is no need for one to predict the other and generate the paired prediction. With this in mind, one prediction is made for each input instance. In other words, advanced pose transformation is performed on each input instance, instead of making each instance predict all high-level instances. In the second stage, the tuning mechanism will extract the required information from the hidden capsules, and fuse it to synthesize the high-level instances. In this way, significant savings in memory and computational requirements is provided, which are otherwise wasted on generating invalid pairs and redundant information. Also, the vector-form weights, used in the tuning phase 18, ensure that each feature in the pose of higher-level capsule is inferred from the corresponding feature in the pose of the hidden capsules, and is not impacted by other kinds of features, while in previous CapsNets, the features in each middle capsule are given the same weights when predicting outputs. In the present invention, the parameters in both phases are trainable, so that they can accumulate knowledge during training. In the previous CapsNets, only the first step is trainable to serve this function.

In general, different from the previous CapsNets with pair-wise transformation and routing, FC-PT-Caps first performs capsule-wise prediction followed by feature-wise tuning. Following the above notation, the total number of training parameters for FC-PT-Caps can be calculated as follows: For the capsule-wise prediction phase, Cᵢₙ-many transformation matrices result in Cᵢₙ×Nᵢₙ×Nₒᵤₜ parameters; then for the feature-wise tuning phase, Cᵢₙ×Cₒᵤₜ-many vector weights lead to Cᵢₙ×Cₒᵤₜ×Nₒᵤₜ-many parameters. Thus, FC-PT-Caps has a total of Cᵢₙ×Nₒᵤₜ×(Nᵢₙ+Cₒᵤₜ)-many parameters compared to the Cᵢₙ×Cₒᵤₜ×Nᵢₙ×Nₒᵤₜ-many parameters in previous CapsNets. It can be seen that the difference in the number of parameters of FC-PT-Caps and previous CapsNets is only affected by the values of Nᵢₙ and Cₒᵤₜ. In this work, the number of capsule-types (C) were empirically chosen to be 2a, where a ∈, and the dimension of capsule vectors (Nᵢₙ) is chosen. Both of these hyperparameter choices correspond to the setup commonly used by previous CapsNets. Based on these choices, it is evident that FC-PT-Caps is much more lightweight than others and can reach the same destination using less parameters, which means that the projection from input to output space is more sparse. Hence, the overfitting problem, which usually affects the previous CapsNets, can be properly avoided, making the presented PT-CapsNet model and the models presented in FIGS. 3 and 4 more flexible to be generalized to more complex datasets.

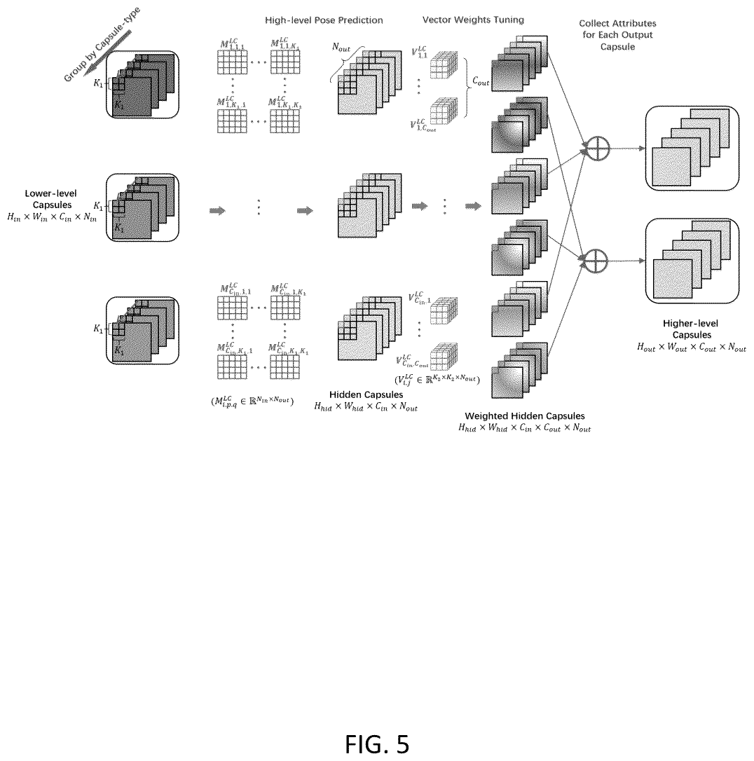

There is seen in FIG. 5, an example of a locally connected PT capsule layer (LC-PT-Caps). Fully connected (FC) capsule layers focus more on extracting global information, but are not that conducive to capturing diverse local relationships between adjacent locations, which are very important for many computer vision tasks. Stacking only the FC layers for CapsNet will also generate a large amount of parameters, requiring extensive memory and computational resources, and leading to weak generalization ability and the overfitting problem. Hence, to address these issues, and further enhance the applicability of the present invention, a locally connected PT-CapsNet is also presented, which is referred to as the LC-PT-Caps layer 30. Instead of one capsule-type corresponding to a single capsule like in an FC layer, in locally connected layer, one capsule-type 32 encloses a map of capsules 34. Therefore, to represent the flow between different LC-PT-Caps layers, the capsule tensor domain also contains location axes, in addition to the capsule-type axis and capsule dimension axis. Let X^{LC}∈ [symbol] ^{Cin×Nin×Hin×Win} and Y^{LC}∈ [symbol] ^{Cout×Nout×Hout×Wout} denote the input and output feature maps, respectively, for the LC-PT-Caps layer l. Similar to the FC-PT-Caps layer, the low-level pose of an input capsule map is first evolved to high-level pose. For each type of capsule map, a sliding window of matrices in R^{Nin×Nout} is used, with the reception field of [K1×K1] shared among different locations, to do the matrix multiplication with each capsule vector within the reception field. The resulting vectors in one field are summed to get the hidden capsule vector 36 at the corresponding location and capsule-type. Concatenating the hidden vectors based on capsule-type, gets the hidden map H^{LC}∈ [symbol] ^{C}^{ᵢₙ}^{×N}^{ₒᵤₜ}^{×H}^{_{hid}}^{×W}^{_{hid}}. This process can be expressed as:

$$\text{?} = {{\sum }_{p}}^{{K}_{1}} {{\sum }_{q}}^{{K}_{1}} \text{?} \cdot {M}_{i , p , q}^{LC} , \qquad ( 5 )$$

$$\text{?} \text{indicates text missing or illegible when filed}$$

where \vec{h}_{i,a,b}^{LC} and \vec{x}_{i,a}_{ₚ}_{,b}_{_{q}}^{LC} indicate the evolved hidden vector at [a, b] position, and the capsule vector at [aₚ, b_{q}] position of i^{th} input capsule-type, respectively, and M_{i,p,q}^{LC} denotes the matrix at [p, q] position of the sliding window for the i^{th} input capsule-type. This operation is capsule-type-wise, so with the shared matrices, one type of input capsules will make predictions for one type of hidden capsules. Then, there will be Cᵢₙ-many groups of sliding matrices, which generate Cᵢₙ×K₁×K₁×Nᵢₙ×Nₒᵤₜ-many parameters for the first prediction stage.

For the second stage of LC-PT-Caps, similar to the tuning step in FC-PT-Caps described above, information from hidden capsules is adjusted and fused to get the higher-level capsules 38. To produce each output capsule map in [symbol] ^{N}^{ₒᵤₜ}^{×H}^{ₒᵤₜ}^{×W}^{ₒᵤₜ} a sliding cube of weights, V^{LC}∈ [symbol] ^{K}^{₂}^{×K}^{₂}^{×N}^{ₒᵤₜ}, is used to perform element-wise multiplication at positions of each type of hidden capsule map, where [K₂, K₂] represents the window size (reception field size), and Nₒᵤₜ represents the weights of the Nₒᵤₜ features at each position. Then, to exploit the features from each capsule type, the weighted hidden capsule vectors 38 are summed together to get the high-level capsule vector 40 at the corresponding location. By concatenating the resulting capsule maps based on output capsule-type, it is possible to get the final map Y^{LC}∈ [symbol] ^{C}^{ₒᵤₜ}^{×N}^{ₒᵤₜ}^{×H}^{ₒᵤₜ}^{×W}^{ₒᵤₜ}. The process can be expressed as:

$$\text{?} = {{\sum }_{i}}^{Cin} {{\sum }_{p}}^{{K}_{2}} {{\sum }_{q}}^{{K}_{2}} \text{?} \times \text{?} , \qquad ( 6 )$$

$$\text{?} \text{indicates text missing or illegible when filed}$$

where \vec{v}_{j,i,p,q}^{LC} is the vector weights at [p, q] position of the sliding cube for i^{th} hidden capsule map to produce j^{th} output capsule map, \vec{y}_{j,a,b} is the capsule vector at [a, b] position of the j^{th} output capsule map, and \vec{h}_{i,a}_{ₚ}_{,b}_{_{q}}^{LC} is the capsule vector at [aₚ, b_{q}] position of the i^{th} hidden capsule group. The second stage is feature-wise adjustment, such that for predicting one type of capsule map, Cᵢₙ-many shared cubes will be required, which leads to Cₒᵤₜ×Cᵢₙ×K₂×K₂×Nₒᵤₜ-many parameters.

For both phases in the LC-PT-Caps layer, K determines the reception field size when capturing local features, and due to the shared weights among locations, it is also a lightweight structure compared to previous CapsNets.

As seen in FIG. 2, a PT-CapsNet model was constructed for image classification by using FC-PT-Caps layer (as seen FIG. 4) and LC-PT-Caps layer (as seen FIG. 5). This architecture for classification is composed of six main blocks: one convolution block, four LC-PT-Caps blocks, and one FC-PT-Caps block. Convolution block is used to extract the initial features from the input images. It contains a 3×3 convolution layer, followed by a batch normalization (BN) layer and a ReLU activation layer. To transfer the initial features to capsule domain, an additional axis is added to the feature map, representing the capsule vector dimension, so that the initial capsule vector dimension is 1.

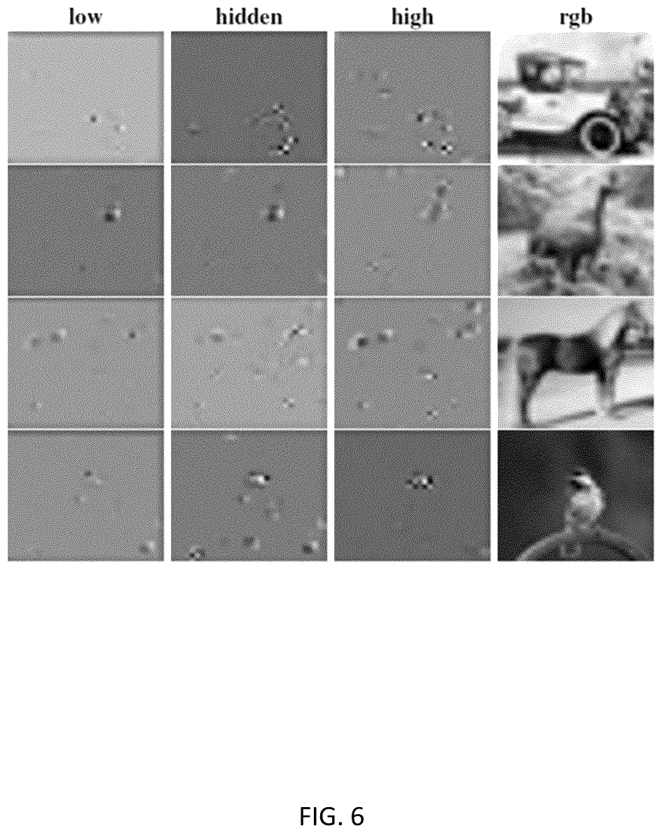

For each LC-PT-Caps block, there are five capsule units and one concatenation unit. For each capsule unit, BN is adopted right after one LC-PT-Caps layer and before the non-linearity function. K₁=1 and K₂∈[1, 3] is set for all the LC-PT-Caps layers. The first capsule unit in each block is treated as a transition unit to process the input capsule maps from the previous block. The transition unit in the first LC-PT-Caps block has K₂=3, while the rest has K₂=1. The second capsule unit is used to change the size of the capsule feature maps by modifying the stride of the sliding cube at the second phase, hence it is referred to as the down-sampling unit. The feature map size is not changed in the first LC-PT-Caps block, where the stride is set to be 1. For the remaining three blocks, the stride is set to be 2. The third and fourth capsule units (pink squares) are used to further process the capsule outputs from the down-sampling block. K₂ is set to 3 and 1 for these blocks, and stride equal to 1. The down-sampling unit and the following two units together form a sequential structure to study a mapping for the outputs from the transition unit. The fifth unit, referred to as the inception unit (green squares), is used to learn a different mapping for the outputs from the transition unit. K₂ is set to be 1, and to match the feature map size for this connection, the stride is set equal to the stride in the parallel down-sampling unit. The concatenation unit is used to merge the outputs from the sequential block and the inception unit along the capsule-type axis. This architecture is a combination of the two mappings with their outputs concatenated into a single capsule output domain. In this way, the CapsNet width is scaled by widening the capsule-type channel for the feature maps to make the model capture various instances and easier to train. After four LC-PT-Caps blocks, the FC-PT-Caps block is the final classification block. For the feature map generated from the last LC-PT-Caps block, the H, W axes are concatenated with the capsule-type axis to reshape it into the FC capsule domain, which only has the capsule-type and feature-dimension axes. The resulting feature map is in R^{H×W×C,N}. Then, FC-PT-Caps layer is adopted followed by BN and a non-linearity function to project the feature map into the class space R^{cls,16}, where cls represents the number of classes. To find the best way of acquiring the final logits of the class capsules, an ablation study is conducted to compare the typical 12 norm logits and ‘generated logits’, which refer to using an additional FC-PT-Caps layer to generate capsules with only one element representing the classification probability. Since the experimental results show that the ‘generated logits’ perform better than the 12 norm logits, another FC-PT-Caps layer is added, in which the output capsule domain is R^{[cls,1]}, to get the final prediction. Visualization of focus of capsules in the 2nd transition unit are provided in FIG. 6 to illustrate the semantic information represented by each level of capsules.

The convolution layer was replaced and the FC layer in the YOLO-v5 baseline with LC-PT-Caps layer and FC-PT-Caps layer, respectively, to build the PT-CapsNet-based object detection model. ResNet-101 pretrained on CSPNet was adopted as the backbone. The details of the PT-Caps-Yolov5 architecture, designed for object detection, are provided in Table 1. The first column shows the ID of the module. The second column (named from) indicates where the input feature maps are from. More specifically, −1 indicates that the input feature maps are from the output of the previous layer, and [−1,a] means that one input is from the previous layer and the other input is from layer #a. n (third column) indicates how many times a module is repeated. The fourth column is the module name, and fifth column contains the argument details of each module. Argument format for Focus, Caps, BottleneckCSP, and SPP modules is [input capsules, input capsule dimension, output capsules, output capsule dimension, K2, stride]. K1=1 is set for all PT-capsule layers. Argument format for Upsample module is [multiplier for spatial size, upsampling algorithm]. Argument format for Concat module means the concatenation is performed along the capsule axis. The arguments for the Detect layer are presented across three lines in the table. The first line represents the number of classes. The second line indicates the size of anchors for each source of feature maps, and the third line represents the corresponding number of input capsules and input capsule dimension of each source of feature maps.

TABLE 1
Architecture of PT-Caps-YOLOv5 model to be used for object detection

| # | from | n | module | arguments |
|---|---|---|---|---|
| 0 | −1 | 1 | Focus | [1, 3, 16, 8, 3] |
| 1 | −1 | 1 | Caps | [16, 8, 32, 8, 3, 2] |
| 2 | −1 | 1 | BottleneckCSP | [32, 8, 32, 8, 1] |
| 3 | −1 | 3 | Caps | [32, 8, 64, 8, 3, 2] |
| 4 | −1 | 1 | BottleneckCSP | [64, 8, 64, 8, 3] |
| 5 | −1 | 1 | Caps | [64, 8, 64, 16, 3, 2] |
| 6 | −1 | 3 | BottleneckCSP | [64, 16, 64, 16, 3] |
| 7 | −1 | 1 | Caps | [64, 16, 128, 16, 3, 2] |
| 8 | −1 | 1 | SPP | [128, 16, 128, 16, [5, 9, 13]] |
| 9 | −1 | 1 | BottleneckCSP | [128, 16, 128, 16, 1] |
| 10 | −1 | 1 | Caps | [128, 16, 64, 16, 1, 1] |
| 11 | −1 | 1 | Upsample | [(1, 2, 2), ‘nearest’] |
| 12 | [−1, 6] | 1 | Concat | [1] |
| 13 | −1 | 1 | BottleneckCSP | [128, 16, 64, 16, 1] |
| 14 | −1 | 1 | Caps | [64, 16, 64, 8, 1, 1] |
| 15 | −1 | 1 | Upsample | [(1, 2, 2), ‘nearest’] |
| 16 | [−1, 4] | 1 | Concat | [1] |
| 17 | −1 | 1 | BottleneckCSP | [128, 8, 64, 8, 1] |
| 18 | −1 | 1 | Caps | [64, 8, 64, 8, 3, 2] |
| 19 | [−1, 14] | 1 | Concat | [1] |
| 20 | −1 | 1 | BottleneckCSP | [128, 8, 64, 16, 1] |
| 21 | −1 | 1 | Caps | [64, 16, 64, 16, 3, 2] |
| 22 | [−1, 10] | 1 | Concat | [1] |
| 23 | −1 | 1 | BottleneckCSP | [128, 16, 128, 16, 1] |
| 24 | [17, 20, 23] | 1 | Detect | 20 |
| | | | | [10, 13, 16, 30, 33, 23], [30, 61, |
| | | | | 62, 45, 59, 119], [116, 90, 156, 198, |
| | | | | 373, 326] |
| | | | | [64, 8], [64, 16] [128, 16]] |

For the thermal anomaly identification, an extensive amount of IR data (paired with visual RGB images) was collected from various types of buildings in different climate conditions. Ground truth for every single IR image is provided by building performance experts for model training and evaluation. The ground truth annotation is an especially cumbersome process, which requires the annotator to draw a tight boundary around every thermal anomaly on every IR image. In ground truth annotation, two types of anomalies, namely thermal infiltration/exfiltration and thermal bridge were considered. The dataset consists of 2417 images with ground truth. The dataset was split into training, and testing set by a ratio of 4:1, and one-fifth of the training set was used as the validation set. The mean Intersection over Union (mIoU) was adopted as the first evaluation metric. On the segmentation masks, red color corresponds to a thermal bridge while green color corresponds to infiltration/exfiltration.

First, various validation splits were evaluated. More specifically, the training set was divided into five equal parts. Then, one of the five parts is used for validation and the remaining four parts for training. This is repeated five times by using each of the parts for validation at each trial. The performance of these five splits is compared on the testing set, and the one with the highest mIoU score is chosen as the validation split for the future experiments. The models are trained for 120 epochs. The initial learning rate is 0.01 with polynomial learning rate decay scheduler. The input images are resized to 513×513, and normalized into one channel. For data augmentation, 4-pixel zero padding was performed at all sides, and a horizontal flip performed with a probability of 0.5. Then, 513×513 patches were randomly cropped from the transformed images. An Adam optimizer was used and a batch size of 2 images per batch. The results obtained with different splits is seen in Table 2.

TABLE 2
Experiments for selecting validation split

| Model | Val Set | Val-mIoU | Test-mIoU |
|---|---|---|---|
| CapsLab-ResNet | split-0 | 0.22 | 0.2576 |
| | split-1 | 0.2337 | 0.2673 |
| | split-2 | 0.257 | 0.2796 |
| | split-3 | 0.2285 | 0.2624 |
| | split-4 | 0.2286 | 0.2565 |

It can been seen that Split-2 outperforms other splits by 1.23%-2.31% on the testing set. Therefore, Split-2 was employed to train the proposed model in the remainder of the experiments. In addition, the impact of three factors on the model performance was investigated. These are (i) the choice of the backbone model, (ii) input data modalities, and (iii) different data augmentation combinations. As for the backbone model, two backbones were employed—ResNet101 and DRN-D-54—in the experiments. For input data modality, the performance of using only IR images was compared with using both IR and RGB images via data-level fusion.

Two different data augmentation combinations were also compared. One is the combination of random horizontal flip (HF) and random crop (RC). The other just adds random Gaussian blur (GB) based on the first combination. In this experiment, all models are trained for 150 epochs. With these training setups, a total of eight sets of evaluation results were used and which are shown in Table 3.

TABLE 3
Results of variants of CapsLab

| Backbone | Mode | Augmentation | Val-mIoU | Test-mIoU |
|---|---|---|---|---|
| ResNet | IR | HF-RC | 0.2999 | 0.3115 |
| | IR + RGB | | 0.2959 | 0.3043 |
| DRN | IR | | 0.29 | 0.3231 |
| | IR + RGB | | 0.3003 | 0.3 |
| ResNet | IR | HF-RC-GB | 0.2961 | 0.314 |
| | IR + RGB | | 0.2919 | 0.2927 |
| DRN | IR | | 0.2789 | 0.324 |
| | IR + RGB | | 0.297 | 0.3014 |

CapsLab, using the DRN as the backbone and using only the IR images, generates the best results compared to other settings. The model achieves the best mIoU score when using the second augmentation combination (HF-RC-GB). Furthermore, a comparison with three state-of-the-art base-line segmentation methods, namely DeepLabV3+, MSOCR and Mask-Former was performed. MSOCR employs a multi-scale attention mechanism, which allows the network to combine the predictions from multiple inference scales at pixel level. MaskFormer considers the global segmentation mask as a set of binary masks. Different from DeepLabV3+, which only relies on the CNN backbone to encode and decode, MaskFormer uses a CNN backbone network as the encoder and a transformer as the decoder. The experimental setup used for the baselines is the same as CapsLab. The models were fine-tuned on our the dataset by using learning rates of 0.01, 0.005 and 0.0001 for DeepLabV3+, MSOCR, and MaskFormer, respectively. Based on the initial experiments, which showed that using IR images would provide higher mIoU scores, the baseline models were trained with IR images. The performances of different methods are shown in Table 4 below:

TABLE 4
Overall performance of different models on test data

| Method | mIoU |
|---|---|
| DeepLab V3+ | 0.2293 |
| MSOCR | 0.2592 |
| MaskFormer | 0.2961 |
| CapsLab-ResNet | 0.323 |
| CapsLab-DRN (Proposed) | 0.324 |

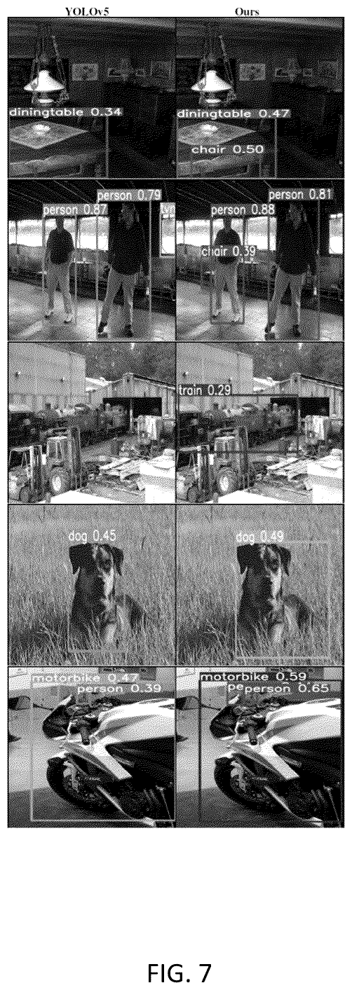

As can be seen, the CapsLab provides the highest mIoU score compared to the other methods. This indicates that CapsLab is doing a better job in tightly segmenting the regions that it detects. Example images showing the outputs of different models, and their mIoU and AIM scores are presented in FIG. 7. As can be seen, mIoU is a strict metric focusing more on the overlap, and it has a strong penalty when predicted area does not closely overlap with the ground truth.

An ablation study focused on three aspects of the PTCapsNet. First, the prediction and tuning type/order was investigated. For the PT-CapsNet, the capsule-wise prediction for high-level pose is performed first, followed by the feature-wise tuning for the higher level capsule-type. Yet, it is also reasonable to first perform feature-wise prediction for higher-level capsule-type, followed by the capsule-wise tuning for higher-level pose. The second aspect of ablation study is about the logits. 12 norm is used most commonly to calculate the logits for vector form capsules. It is also sensible to apply an additional capsule layer to generate class logits for each capsule. The third aspect of the ablation study is related to the non-linearity functions. In original CapsNet, the squash function is used to normalize capsules. The ReLU function is employed as the non-linearity for the primary capsules. The swish function is also proved to work well with large architectures and advanced tasks. To investigate the best prediction and tuning type/order, the logit generation method, and the non-linearity function, experiments were conducted on MNIST, FashionMNIST, and KMNIST datasets covering 12 combinations shown in Table 5.

TABLE 5
Ablation study on MNIST, Fashion-MNIST, and KMNIST datasets

| Models | | | Testing error | | |
|---|---|---|---|---|---|
| Prediction | Logits | Activation | MNIST | F-MNIST | KMNIST |
| Feature- | GL | ReLU | 0.75 | 8.29 | 4.35 |
| wise | | Squash | 0.81 | 8.42 | 5.13 |
| prediction | | Swish | 0.76 | 8.12 | 4.2 |
| | L2 | ReLU | 88.65 | 90 | 90 |
| | | Squash | 1.66 | 10.68 | 10.39 |
| | | Swish | 42.26 | 21.76 | 10.36 |
| Capsule- | GL | ReLU | 0.63 | 7.77 | 3.47 |
| wise | | Squash | 0.74 | 7.84 | 5.02 |
| prediction | | Swish | 0.64 | 8.1 | 3.58 |
| | L2 | ReLU | 88.65 | 90 | 90 |
| | | Squash | 1.52 | 10.44 | 9.54 |
| | | Swish | 89.9 | 74.4 | 66.06 |

A simpler architecture was used for this part, which is composed of two convolution layers as backbone, and two PT-Capsule layers—one LC-PT-Caps and one FC-PT-Caps layer—as the capsule part. The convolution layers are followed by BN and ReLU activation, and the capsule layers are followed by BN and the choice of non-linearity. The number of channels for the two convolution layers are 64 and 128, and the kernel size and stride for both layers are 3×3 and 2, respectively. The number of capsule types and capsule dimension for the LC-PT-Caps and FC-PT-Caps are [32, 8] and [10, 16], respectively. The LC-PT-Caps has a reception field of 3×3 with cubic stride of 2. Each model is trained for 100 epochs with SGD optimizer, and the batch size and initial learning rate are equal to 128 and 0.1, respectively. The learning rate decay is 0.1 for every 50 epochs. 4-pixel zero padding was performed at all sides, along with a horizontal flip with a probability of 0.5 for data augmentation. The testing error in Table 5 is calculated as the average value of 5 runs. It can be seen from Table 4 that (i) models with capsule-wise prediction for high-level pose and the feature-wise tuning for the higher-level capsule-type perform better than the models with feature-wise prediction for higher-level capsule-type and the capsule-wise tuning for higher-level pose in most cases; (ii) ‘Generated logits’ (GL) consistently outperforms the 12-norm based logits method; and (iii) although the squash function works well with 12-norm based method, it cannot surpass the performance of ReLU function used with the GL method. Thus, to construct the best PT-CapsNet, the most promising options were combined—pose prediction, GL method, and ReLU—for the remainder of the experiments.

The classification model, which has 0.29M parameters, was compared with six CapsNet-based methods with respect to robustness to affine transformations for classification on CIFAR10. The methods were compared and their number of training parameters are CapsNet (8.5M), EM-Caps (0.32M), GCaps (7.8M), SR-CapsNet (3.2M), DeepCaps (8.5M), and SOVNET (7.3M). Five variations of the training and test sets were created by randomly transforming data. The combination of translation and rotation was considered. The translation extent and the rotation degree were chosen from the following 5 combinations: [0 pixel, 0°], [2 pix., 30°], [2 pix., 60°], [2 pix., 90°], and [2 pix., 180°]. Each model was trained on the five transformed versions of the training set separately, and then tested them on all five transformed versions of the test set. Thus, for each model, there are 25 robustness evaluation results summarized in Table 6 below.

TABLE 6
Affine transformation experiments on CIFAR-10 dataset

| | | | | | |
|---|---|---|---|---|---|
| Models | (0, 0°) | (2, 30°) | (2, 60°) | (2, 90°) | (2, 180°) |

Training on Untransformed CIFAR-10

| | | | | | |
|---|---|---|---|---|---|
| CN | 68.28 | 55.57 | 43.55 | 37.48 | 30.89 |
| EM | 62.85 | 49.28 | 41.27 | 34.73 | 29.9 |
| GC | 49.54 | 38.45 | 31.89 | 30.88 | 27.7 |
| SR | 91.49 | 62.25 | 42.18 | 36.89 | 30.26 |
| DC | 76.76 | 67.97 | 53.56 | 45.22 | 35.67 |
| SN | 88.34 | 47.57 | 42.24 | 43.75 | 43.52 |
| Ours | 91.21 | 70.18 | 50.41 | 46.79 | 40.56 |

Training on Affine Transformation by (2, 30°)

| | | | | | |
|---|---|---|---|---|---|
| CN | 73.45 | 69.87 | 61.17 | 52.29 | 45.58 |
| EM | 70.24 | 66.63 | 59.10 | 50.93 | 42.26 |
| GC | 49.5 | 48.88 | 45.75 | 42.93 | 38.74 |
| SR | 90.36 | 89.15 | 78.07 | 65.37 | 50.07 |
| DC | 84.24 | 82.54 | 74.63 | 63.54 | 48.63 |
| SN | 86.58 | 85.35 | 82.51 | 79.14 | 69.64 |
| Ours | 90.16 | 88.41 | 85.2 | 78.5 | 70.7 |

Training on Affine Transformation by (2, 60°)

| | | | | | |
|---|---|---|---|---|---|
| CN | 70.26 | 67.69 | 66.62 | 60.04 | 47.99 |
| EM | 66.53 | 65.09 | 63.21 | 58.04 | 47.61 |
| GC | 49.63 | 50.31 | 48.84 | 47.43 | 43.11 |
| SR | 86.18 | 87.78 | 84.68 | 80.21 | 60 |
| DC | 83.92 | 83.63 | 82.79 | 78.09 | 60.02 |
| SN | 82.86 | 83.63 | 83.57 | 83.06 | 80.89 |
| Ours | 87.34 | 86.82 | 85.49 | 84.97 | 81.7 |

Training on Affine Transformation by (2, 90°)

| | | | | | |
|---|---|---|---|---|---|
| CN | 67.81 | 65.64 | 65.46 | 64.35 | 52.79 |
| EM | 64.33 | 63.0 | 62.7 | 61.42 | 52.08 |
| GC | 49.98 | 51.24 | 50.63 | 49.95 | 46.59 |
| SR | 85.17 | 83.97 | 83.26 | 82.15 | 67.73 |
| DC | 82.91 | 82.78 | 82.66 | 82.62 | 68.34 |
| SN | 83.33 | 82.76 | 82.58 | 82.79 | 82.22 |
| Ours | 85.42 | 84.77 | 83.85 | 82.84 | 75.91 |

Training on Affine Transformation by (2, 180°)

| | | | | | |
|---|---|---|---|---|---|
| CN | 61.08 | 59.53 | 60.04 | 59.85 | 59.9 |
| EM | 57.57 | 55.89 | 56.85 | 56.35 | 55.2 |
| GC | 39.09 | 41.03 | 41.43 | 41.25 | 41.08 |
| SR | 82.32 | 81.17 | 81.02 | 80.88 | 80.35 |
| DC | 81.12 | 80.81 | 80.64 | 81.05 | 80.92 |
| SN | 82.50 | 81.80 | 81.78 | 81.95 | 81.82 |
| Ours | 82.76 | 82.72 | 82.68 | 82.02 | 82.51 |

PT-CapsNet of model outperforms others in most of the cases, indicating that PT-CapsNet is more robust. In only eight out of 25 cases, SR-CapsNet, SOVNET, and DeepCaps provide better accuracy, but their number of parameters are much higher than ours (by almost 11, 25, and 29 times). Furthermore, the performance of PTCapsNet on the un-transformed dataset is much better than the other CapsNet baselines. PT-CapsNet having the least number of parameters among others further demonstrates that the robustness mostly comes from the framework and the sparse projection space.

Image classification, semantic segmentation, and object detection experiments were conducted to compare the proposed PT-CapsNets with several CNN-based models on various datasets. To perform a commensurate comparison, all the models were reproduced in PyTorch framework, and reported our reproduced results. For image classification, CIFAR-10, CIFAR-100, and Fashion-MNIST datasets were, and ResNet-110, WRN-28-10, and DenseNet-100 adopted as baseline models. For semantic segmentation, the ISIC2018 dataset was used, and U-Net and DeepLabv3+ adopted as the baselines. For object detection, PASCAL VOC dataset was used, and compare with YOLO-v5. The convolution layer and the FC layer in the baselines was replaced with LC-PT-Caps layer and FC-PT-Caps layer, respectively, to build PT-CapsNet-based models. For PTDeepLabv3+ and PT-YOLO-v5, ResNet-101 was adopted pretrained on ImageNet and CSPNet, as the backbones, respectively.

For the capsule network, both the number of capsule types and the capsule dimension need to be considered. The architecture details for PT-Caps-ResNet-110, PT-Caps-WRN-28 and PT-Caps-DenseNet-100 are provided in Tables 7, 8 and 9, respectively. In each table, the first column indicates the blocks of each model, the second column shows the output feature map size of the corresponding block, and the third column shows the argument details. More specifically, the third column contains (K1;K2) (where K1 and K2 are the reception field size of the prediction phase and the tuning phase in our PT-CapsNet), the number of capsules, capsule dimension and the number of times a PT-Capsule block is repeated.

TABLE 7
Architecture of the PT-Caps-ResNet110 model used for the
classification task. n is the number of classes.

| layer | size | model |
|---|---|---|
| caps1 | 32 × 32 | (1, 3), 8, 4 |
| caps2.x | 32 × 32 | $[ \begin{matrix}( 1 , 3 ) , & 8 , & 4 \\ ( 1 , 3 ) , & 8 , & 4\end{matrix} ] \times 18$ |
| caps3.x | 16 × 16 | $[ \begin{matrix}( 1 , 3 ) , & 16 , & 4 \\ ( 1 , 3 ) , & 16 , & 4\end{matrix} ] \times 18$ |
| caps4.x | 8 × 8 | $[ \begin{matrix}( 1 , 3 ) , & 16 , & 4 \\ ( 1 , 3 ) , & 16 , & 8\end{matrix} ] \times 18$ |
| pooling | 1 × 1 | |
| PT-FC-Caps | — | n, 1 |

TABLE 8
Architecture of the PT-Caps-WRN28 model used for the classification task. The
widening factor is applied on both capsule channel and attribute channel. n is the number of
classes.

| layer | size | model |
|---|---|---|
| caps1 | 32 × 32 | (1, 3), 16, 2 |
| caps2.x | 32 × 32 | $[ \begin{matrix}( 1 , 3 ) , & 80 , & 2 \\ ( 1 , 3 ) , & 80 , & 4\end{matrix} ] \times 4$ |
| caps3.x | 16 × 16 | $[ \begin{matrix}( 1 , 3 ) , & 80 , & 4 \\ ( 1 , 3 ) , & 80 , & 8\end{matrix} ] \times 4$ |
| caps4.x | 8 × 8 | $[ \begin{matrix}( 1 , 3 ) , & 160 , & 8 \\ ( 1 , 3 ) , & 160 , & 8\end{matrix} ] \times 4$ |
| pooling | 1 × 1 | |
| PT-FC-Caps | — | n, 1 |

TABLE 9
Architecture of the PT-Caps-DenseNet100 model used for the classification task.
This model is built from 100 capsule layers. caps.x denotes the capsule bottleneck block, and
TD represents the capsule transition down block. Column m shows the number of capsules
and capsule dimension at the end of the block.

| layer | size | model | m |
|---|---|---|---|
| caps1 | 32 × 32 | (1, 3), 12, 3 | [12, 3] |
| caps2.x | 32 × 32 | $[ \begin{matrix}( 1 , 1 ) , & 24 , & 3 \\ ( 1 , 3 ) , & 6 , & 3\end{matrix} ] \times 16$ | [108, 3] |
| TD | 16 × 16 | (1, 1), 54, 3 | [54, 3] |
| caps3.x | 16 × 16 | $[ \begin{matrix}( 1 , 1 ) , & 24 , & 3 \\ ( 1 , 3 ) , & 6 , & 3\end{matrix} ] \times 16$ | [150, 3] |
| TD | 8 × 8 | (1, 1), 75, 3 | [75, 3] |
| capa4.x | 8 × 8 | $[ \begin{matrix}( 1 , 1 ) , & 24 , & 3 \\ ( 1 , 3 ) , & 6 , & 3\end{matrix} ] \times 16$ | [171, 3] |
| pooling | 1 × 1 | | [171, 3] |
| PT-FC-Caps | — | n, 1 | [n, 1] |

The results for image classification are summarized in Tables 10, 11, and 12 for three different datasets.

TABLE 10
Image classification results on CIFAR10 dataset

| Models | top-1 acc. | MAC. | # params |
|---|---|---|---|
| ResNet | 92.69 | 255.27M | 1.73M |
| PT-CapsResNet | 93.59 | 225.7M | 1.12M |
| WRN | 95.95 | 5.25G | 36.48M |
| PT-CapsWRN | 95.98 | 3.51G | 19.21M |
| DenseNet | 95.33 | 296.48M | 769.16K |
| PT-CapsDenseNet | 95.71 | 262.38M | 727.11K |

TABLE 11
Image classification results on CIFAR100 dataset

| Models | top-1 acc. | MAC. | # params |
|---|---|---|---|
| ResNet | 70.32 | 255.28M | 1.74M |
| PT-CapsResNet | 71.39 | 225.79M | 1.16M |
| WRN | 81.09 | 5.25G | 36.54M |
| PT-CapsWRN | 81.58 | 3.51G | 19.23M |
| DenseNet | 77.12 | 296.51M | 800.03K |
| PT-CapsDenseNet | 78.36 | 261.03M | 655.28K |

TABLE 12
Image classification results on FashionMNIST dataset

| Models | top-1 acc. | MAC. | # params |
|---|---|---|---|
| ResNet | 94.36 | 195.22M | 1.73M |
| PT-CapsResNet | 95.28 | 171.5M | 1.12M |
| WRN | 95.34 | 4.02G | 36.48M |
| PT-CapsWRN | 95.57 | 2.68G | 19.21M |
| DenseNet | 95.39 | 226.66M | 768.73K |
| PT-CapsDenseNet | 95.99 | 200.37M | 726.45K |

The top-1 accuracy was reported, to validate the effectiveness, and the total number of parameters (#params) and the total number of multiply-and-accumulates (MAC.) to show the compactness of our PT-CapsNets. It can be seen that, the PTCapsNet slightly outperforms all three of the CNN baselines, while providing considerable reduction in the number of parameters and the amount of computation at the same time.

The segmentation results are summarized in Table 13, listing the mean Intersection over Union (mIoU) and the number of parameters for each model. PT-CapsNets can not only improve the mIoU of UNet and DeepLabv3+ by 1.31% and 0.27%, but also provide 36% and 25% parameter reduction, respectively.

TABLE 13
Semantic segmentation results on the ISIC2018 dataset.

| Models | mIoU | # params |
|---|---|---|
| Unet | 65.57 | 31.1M |
| PT-Caps-Unet | 66.86 | 19.8M |
| DeepLaby3+ | 82.85 | 59.3M |
| PT-Caps-DeepLaby3+ | 83.12 | 44.6M |

For object detection, mean average precision (mAP) is used as the performance metric, and the results are evaluated for mAP @0.5 (mAP1), mAP @[0.5:0.95] (mAP2), precision, and recall in Table 14. It can be seen that PT-CapsNet based detection model provides higher precision and comparable mAP with respect to YOLO-v5, with less number of parameters.

TABLE 14
Object detection results on PASCAL VOC dataset

| Models | mAPI | mAP2 | Prec. | Recall | param |
|---|---|---|---|---|---|
| YOLO-v5 | 78 | 52.21 | 54.28 | 83.27 | 7.3M |
| PT-Caps | 78.2 | 52 | 61.2 | 81 | 6.3M |

Across all different tasks and comparison experiments, the PT-CapsNet not only achieves better or on-par performance compared to baselines, but also provides significant parameter reduction, indicating that the performance enhancement and robustness is mostly due to the effective feature descriptor and proposed PT-capsule structure. This shows the great potential for PT-CapsNet to be adopted in wider range of applications.

The present invention may thus employ a novel capsule network structure with prediction-tuning mechanism (PT-CapsNet) to utilize the rich information capacity of capsule networks, and address their limitations. To make the PT-CapsNet widely applicable, fully and locally connected PT-Capsule layers have been introduced, and used to build a PT-CapsNet architecture for classification. The robustness has been compared to affine transformations with several CapsNets baselines. To show the scalability of PT-CapsNet, a large deep learning architectures has been built for classification, segmentation, and object detection tasks, and compared the performance with CNN-based baselines. The present invention also comprises a deep learning method for segmentation of thermal anomalies on building surfaces. More specifically, the present invention contains a Capsule Network based semantic segmentation network for the segmentation of thermal anomalies attributed to different categories on thermal images.

### Example 2

In another example of the present invention, the neutral network may comprise the application of a transformer-based segmentation method, namely Mask2Former, to the autonomous heat anomaly segmentation task. Mask2Former formulates the image segmentation as a set prediction problem, wherein it generates N prediction sets and then assigns a class label and a binary mask to each set. There are four main parts in Mask2Former: backbone, pixel decoder (transformer encoder), transformer decoder, and segmentation head. The backbone is used to extract the initial image features, by mainly adopting a pre-trained ResNet and Swin. The pixel decoder takes the initial features as input, and aims to further explore pixel features as well as formulate the multi-scale feature maps. It is composed of multi-scale deformable attention layers. Based on the query-learning mechanism (with learnable static query content embeddings and static query positional embeddings), the transformer decoder is composed of multiple decoder layers to refine the instance queries, where each decoder layer contains a cross attention layer, a self attention layer, and a feed forward layer. The encoded instance candidates are finally sent to the segmentation head to produce prediction sets. In the segmentation head, a linear layer followed by a softmax nonlinearity is applied for the instance class prediction. Then, an MLP module with two hidden layers is used to transform the instance candidates to mask embeddings. The mask embedding is used to predict a binary mask for the corresponding candidate via matrix multiplication with the mask features generated from the encoder.

Table 14 below shows a comparison of the approach of EXAMPLE 1 to the approach of EXAMPLE 2.

TABLE 14
Performance of Mask2Former and capsule-
based approach on dataset

| MODEL | Pretrain | Backbone | Batchsize | mIoU | AIM |
|---|---|---|---|---|---|
| CapsLab | \ | R101 | 8 | 32.3 | 50.3 |
| CapsLab | \ | DRN | 8 | 32.4 | 48.6 |
| Mask2former | \ | R50 | 8 | 20.3 | — |
| Mask2former | \ | R101 | 8 | 23.1 | — |
| Mask2former | \ | Swin-tiny | 8 | 25.9 | — |
| Mask2former | COCO | R50 | 8 | 34.3 | 50.3 |
| Mask2former | COCO | R101 | 8 | 35.4 | 52.1 |
| Mask2former | COCO | Swin-tiny | 8 | 37.5 | 54.8 |

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A machine learning system for image interpretation, comprising:
an input for receiving a set of thermal image data;
a machine learning module trained to assess the set of thermal image data to detect a thermal anomaly and to classify the thermal anomaly; and
an output for providing an annotated image including a visualization of the thermal anomaly and the classification of the thermal anomaly.

2. The system of claim 1, wherein the machine learning module has been trained with a plurality of thermal images, wherein each of the plurality of thermal images includes a tight boundary around every thermal anomaly.

3. The system of claim 2, wherein each of the plurality of thermal images includes an indication of whether every thermal anomaly comprises a thermal infiltration/exfiltration or a thermal bridge.

4. The system of claim 3, wherein the plurality of thermal images comprises at least 2000 thermal images.

5. The system of claim 4, wherein the machine learning module comprises a capsule network where high level features are assessed with a plurality of parallel capsule blocks and a pooling layer.

6. The system of claim 5, wherein a set of concatenated features from the plurality of parallel capsule blocks and the pooling layer are sent to a capsule block and concatenated with low level features.

7. The system of claim 4, wherein the machine learning module comprises a transformer-based segmentation.

8. The system of claim 7, wherein the transformer-based segmentation comprises Mask2Former that formulates an image segmentation as a set prediction problem and generates N prediction sets and then assigns a class label and a binary mask to each prediction set.

9. A method for identifying anomalies in a thermal image, comprising the steps of:
receiving a set of thermal image data;
assessing the set of thermal image data with a machine learning module to detect a thermal anomaly and to classify the thermal anomaly; and
outputting an annotated image including a visualization of the thermal anomaly and the classification of the thermal anomaly.

10. The method of claim 9, wherein the machine learning module has been trained with a plurality of thermal images, wherein each of the plurality of thermal images includes a tight boundary around every thermal anomaly.

11. The method of claim 10, wherein each of the plurality of thermal images includes an indication of whether every thermal anomaly comprises a thermal infiltration/exfiltration or a thermal bridge.

12. The method of claim 11, wherein the plurality of thermal images comprises at least 2000 thermal images.

13. The method of claim 12, wherein the machine learning module comprises a capsule network where high level features are assessed with a plurality of parallel capsule blocks and a pooling layer.

14. The method of claim 13, wherein a set of concatenated features from the plurality of parallel capsule blocks and the pooling layer are sent to a capsule block and concatenated with low level features.

15. The method of claim 12, wherein the machine learning module comprises a transformer-based segmentation.
